(19) United States
(12) Patent Application Publication
(10) Pub. No.: US 2008/0142653 A1
(43) Pub. Date: Jun. 19, 2008

(54) FREE-STANDING ELECTRONIC DEVICE

(75) Inventors: HSIU-CHANG LAI, Tu-Cheng (TW); ZHENG-HENG SUN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/778,083

(22) Filed: Jul. 16, 2007

(30) Foreign Application Priority Data
Dec. 19, 2006 (CN) 200610201326.6

(51) Int. Cl. G06F 1/16

(52) U.S. Cl. 248/176.3; 248/176.1

(57) ABSTRACT

A free-standing electronic device includes a main body and a stand. The main body includes an enclosure having two end walls, each of the end walls defines a recessed engaging portion in a lower section thereof, and an abutting surface is formed on top of each engaging portion. The stand includes two opposite supporting arms pivotably connectable to the end walls of the enclosure. The stand is capable of being rotated to allow the supporting arms to partially abut against the abutting surfaces of the end walls respectively and support the main body upright.

### BACKGROUND OF THE INVENTION

1. Field of the Invention

The present invention relates to electronic devices, and more particularly to a free-standing electronic device.

2. Description of Related Art

With the development of electronic technology, network devices such as modems, hubs, and switches are widely used. For saving space, the network device is typically provided with an independent supporting apparatus to support the network device to stand upright. However, the supporting apparatus is not connected with the network device, and it is discommodious to move the network device together with the supporting apparatus. Furthermore, the supporting apparatus may be lost when it is not in use.

What is needed, therefore, is a free-standing electronic device, which is able to stand upright and be moved conveniently.

### SUMMARY OF THE INVENTION

An exemplary free-standing electronic device includes a main body and a stand. The main body includes an enclosure having two end walls, each of the end walls defines a recessed engaging portion in a lower section thereof, and an abutting surface is formed on top of each engaging portion. The stand includes two opposite supporting arms pivotably connectable to the end walls of the enclosure. The stand is capable of being rotated to allow the supporting arms to partially abut against the abutting surfaces of the end walls respectively and support the main body upright.

Other advantages and novel features will become more apparent from the following detailed description of preferred embodiment when taken in conjunction with the accompanying drawings, in which:

### BRIEF DESCRIPTION OF THE DRAWINGS

FIG. 1 is an exploded, isometric view of a free-standing electronic device in accordance with a preferred embodiment of the present invention, the free-standing electronic device including a main body, and a stand;

FIG. 2 is another aspect view of the stand of FIG. 1;

FIG. 3 is an assembled view of FIG. 1, showing a folded stated of the free-standing electronic device; and

FIG. 4 is an assembled view of FIG. 1, showing an unfolded state of the free-standing electronic device.

### DETAILED DESCRIPTION OF THE INVENTION

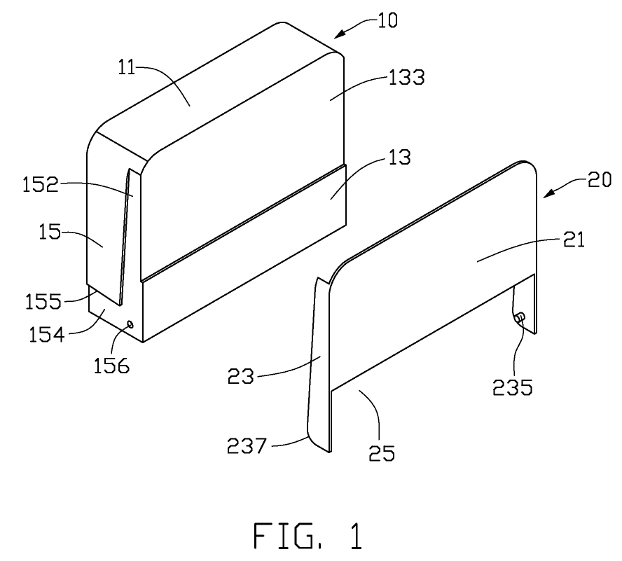

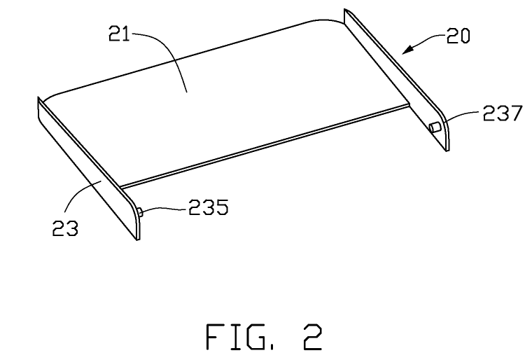

Referring to FIGS. 1 and 2, a free-standing electronic device is provided in accordance with an embodiment of the present invention. The electronic device includes a box-shaped main body 10, and a stand 20.

The main body 10 includes an enclosure 11 having a sidewall 13 and two opposite end walls 15. A concave 133 is defined in an upper portion of the sidewall 13. Each end wall 15 defines a recessed receiving portion 152 adjacent to the sidewall 13, and a recessed engaging portion 154 in a lower section of the end wall 15 communicating with the recessed receiving portion 152. A width of the receiving portion 152 becomes continuously wider from top to bottom. An inclined abutting surface 155 is formed on top of the corresponding engaging portion 154. Each end wall 15 defines a hole 156 in a lower corner portion thereof adjacent to the sidewall 13.

The stand 20 includes two opposite supporting arms 23 and a plate 21 connecting with upper portions of front edges of the supporting arms 23. An opening 25 is defined between the supporting arms 23 below the plate 21. A width of each supporting arm 23 becomes continuously wider from top to bottom. Two pivots 235 are formed on lower portions of inside surfaces of the supporting arms 23 respectively, and the pivots 235 extend toward each other. An arcuate corner 237 is formed on a rear bottom corner of each supporting arm 23, for avoiding the rear bottom corner interfering with a corner of the corresponding end wall 15 formed adjacent a conjunction between the receiving portion 152 and the corresponding engaging portion 154 when the stand 20 is pivoted to stand the main body 10, so as to facilitate rotation of the stand 20.

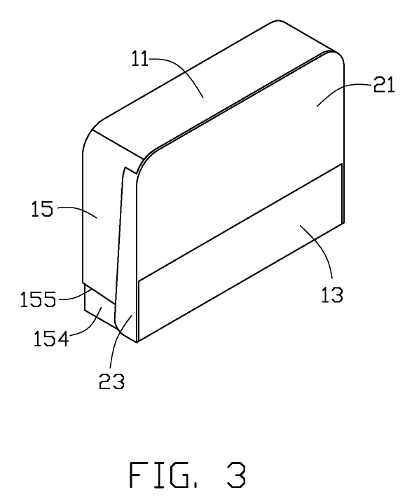

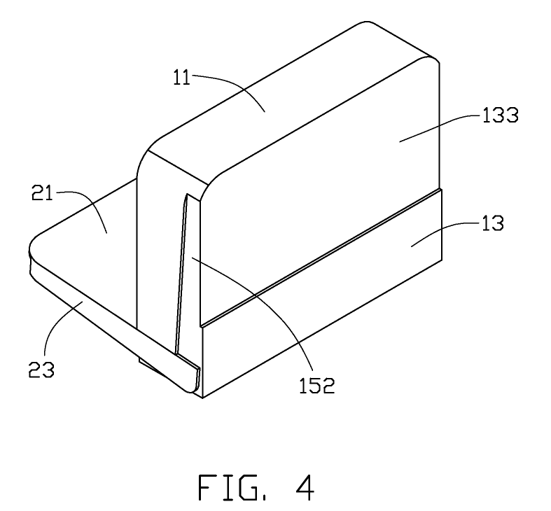

Referring also to FIGS. 3 and 4, in assembly, the supporting arms 23 are expanded out to allow the pivots 235 of the supporting arms 23 to align with the holes 156 of the end walls 15 of the main body 10 respectively. The supporting arms 23 are deformed. Thereafter, the supporting arms 23 are released to restore which makes the pivots 235 engage in the holes 156 of the main body 10 respectively. Thereby, the stand 20 is pivotably attached to the enclosure 11 of the main body 10.

When there is no need to use the stand 20 to support the main body 10 of the electronic device, the stand 20 is rotated anticlockwise toward the sidewall 13 of the enclosure 11 of the main body 10, until the plate 21 of the stand 20 is fittingly received in the concave 133 of the sidewall 13, and the supporting arms 23 are fittingly received in the recessed receiving portions 152 of the end walls 15 of the main body 10 respectively. Thereby, the stand 20 is folded to the enclosure 11 of the main body 10, as shown in FIG. 3, to facilitate relocation of the electronic device.

When the main body 10 is needed to stand upright, the stand 20 is rotated clockwise away from the sidewall 13 of the enclosure 11. The stand 20 is rotated past 180 degrees until the supporting arms 23 of the stand 20 partially engage with the recessed engaging portions 154 of the end walls 15 of the main body 10 respectively, and the supporting arms 23 abut against the abutting surfaces 155 of the end walls 15 respectively. Thereby the main body 10 is supported by the stand 20 approximately upright on a plane, and an angle between the main body 10 and the stand 20 is slightly less than 90 degrees, as shown in FIG. 4.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. A free-standing electronic device, comprising:
a main body comprising an enclosure having two end walls, each of the end walls defining a recessed engaging portion in a lower section thereof, and an abutting surface formed on top of each engaging portion; and
a stand comprising two opposite supporting arms pivotably connectable to the end walls of the enclosure, and the stand capable of being rotated to allow the supporting arms to partially abut against the abutting surfaces of the end walls respectively and support the main body upright.

2. The free-standing electronic device as claimed in claim 1, wherein the enclosure further comprises a sidewall connected between the end walls, each of the end walls defines a hole in a lower corner portion thereof adjacent to the sidewall, and each of the supporting arms forms a pivot on a lower portion of an inside surface thereof for engaging in the hole of a corresponding end wall.

3. The free-standing electronic device as claimed in claim 2, wherein each of the end walls defines a recessed receiving portion adjacent to the sidewall communicating with the corresponding recessed engaging portion, for fittingly receiving a corresponding supporting arm.

4. The free-standing electronic device as claimed in claim 2, wherein the stand further comprises a plate connecting with upper portions of front edges of the supporting arms, an upper portion of the sidewall of the enclosure defines a concave for fittingly receiving the plate of the stand.

5. The free-standing electronic device as claimed in claim 1, wherein when the main body is supported by the stand, an angle formed therebetween is slightly less than 90 degrees.

6. The free-standing electronic device as claimed in claim 1, wherein an arcuate corner is formed on a rear bottom corner of each of the supporting arms to avoid the rear bottom corner interfering with a corner of the corresponding end wall formed adjacent a conjunction between the recessed receiving portion and the corresponding recessed engaging portion when the stand is pivoted to stand the main body.

7. A free-standing electronic device, comprising:
an enclosure having two end walls, each of the end walls forming an abutting surface in a lower section thereof; and
a stand comprising two opposite supporting arms pivotably connectable to the end walls of the enclosure, the stand capable of being folded with the enclosure and being spread out to allow the supporting arms to partially abut against the abutting surfaces of the end walls respectively and support the enclosure upright.

8. The free-standing electronic device as claimed in claim 7, wherein each of the end walls defines a hole below the corresponding abutting surface, and each of the supporting arms forms a pivot on a lower portion of an inside surface thereof for engaging in the hole of a corresponding end wall.

9. The free-standing electronic device as claimed in claim 7, wherein each of the end walls defines a recessed engaging portion below the corresponding abutting surface for receiving a corresponding supporting arm therein when the stand spreads out to support the enclosure upright.

10. The free-standing electronic device as claimed in claim 9, wherein the enclosure further comprises a sidewall, each of the end walls defines a recessed receiving portion adjacent to the sidewall communicating with the corresponding recessed engaging portion, for fittingly receiving the corresponding supporting arm when the stand is folded with the enclosure.

11. The free-standing electronic device as claimed in claim 10, wherein the stand further comprises a plate connecting with upper portions of front edges of the supporting arms, an upper portion of the sidewall of the enclosure defines a concave for fittingly receiving the plate when the stand is folded with the enclosure.

12. The free-standing electronic device as claimed in claim 10, wherein a width of the receiving portion becomes continuously wider from top to bottom.

13. The free-standing electronic device as claimed in claim 7, wherein when the enclosure is supported by the stand, an angle formed therebetween is slightly less than 90 degrees.

14. The free-standing electronic device as claimed in claim 7, wherein an arcuate corner is formed on a rear bottom corner of each of the supporting arms.

15. The free-standing electronic device as claimed in claim 7, wherein the stand is capable of being pivoted substantially 270 degrees from a position where the stand is folded with the enclosure to another position where the stand is spread out to support the enclosure upright.
